(19) United States
(12) Patent Application Publication
(10) Pub. No.: US 2006/0079245 A1
(43) Pub. Date: Apr. 13, 2006

(54) Methods and systems for position co-ordination

(75) Inventor: Roy Uziel Moed, Surrey (GB)

Correspondence Address: Stephen B. Salai, Esq.;Harter, Secrest & Emery LLP, 1600 Bausch & Lomb Place, Rochester, NY, 14604-2711, US

(73) Assignee: MEETME LTD., London (GB)

(21) Appl. No.: 11/232,512

(22) Filed: Sep. 22, 2005

(30) Foreign Application Priority Data
May 6, 2002 (GB) 0509314.1

(51) Int. Cl. H04Q 7/20

(52) U.S. Cl. 455/456.1

(57) ABSTRACT

A position coordination system for coordinating a position of a number of users includes at least one user terminal, at least one mobile communications device, and a network connecting the at least one user terminal and the at least one mobile communications device. The at least one user terminal is configured upon receiving identification information from a first user to determine a second user who is registered with the system to meet the first user and to notify a mobile communications device associated with the second user via the network thereby notifying the second user of the first user's position and facilitating meeting of the two users.

### CROSS-REFERENCE TO RELATED APPLICATION

This application claims priority to Great Britain Application Number 0509314.1, filed May 6, 2005, which is herewith incorporated by reference.

### FIELD OF INVENTION

The present invention relates to systems and methods for co-ordinating the position of a number of users of the systems and methods. More specifically, the present invention relates to methods and systems which enable the automatic notification of a user of the position of another user, thereby facilitating the co-ordination and convergence of the positions of the two users.

### BRIEF SUMMARY OF THE INVENTION

This invention finds application in any number of scenarios in which it is necessary or desirable for users of a system to identify the position of other users of the system. Moreover, it finds application in any scenario in which it is necessary or desirable for the positions of users of a system to converge. One such scenario, which will be utilised for the purposes of example below and throughout the following description, is the convergence of two users at an airport, i.e. the meeting of a passenger, for example, arriving at an airport by a person designated to collect them from the airport.

At present, at airports across the globe, the primary method for linking two people who do not know one another is extremely hit and miss. It requires the person meeting the passenger (i.e. the meeter) arriving at the airport to hold a hand-written or printed note or sign in an obvious manner in the hope that the arriving passenger will see and recognise it in a crowded area such as an airport arrivals hall. Airport arrivals halls or areas are often crammed with people seeking to meet arriving passengers. These meeters can often spend thirty to sixty minutes or even up to several hours waiting for a passenger to come through the arrivals gate, and this can be a very frustrating process. Moreover, flight information available to the waiting meeters, via announcements, screens and short message system (SMS) messages, for example, is limited. It routinely encompasses information only about the flight, e.g. whether it has landed and whether the luggage from that plane is now in the luggage reclaim area.

There are shortcomings with the present arrangement for passengers arriving at an airport, in the present example, also. In order to identify the person meeting them, a passenger needs to scan a sea of names or company logos etc. This can often be particularly large, e.g. 150 feet deep. The notes or signs that are held up can be badly written, too small or contain an incorrect name. Moreover, arriving passengers do not always know what to look out for on a sign. Various possibilities are the passenger's name, the passenger's company name, a client name, a taxi company name or a host name. Furthermore, in many airports, especially those with a restriction on waiting areas, the arriving passenger does not always know where the meeter will be, i.e. will they be inside or outside the terminal building?.

Other problems can be experienced by passengers arriving at an airport or other such location. The person designated to meet them can be late, in the wrong place or may have gone to avail themselves of public conveniences or simply to obtain something to eat or drink. This can be especially distressing in a country that is foreign to the arriving passenger and where the arriving passenger does not know who to call in respect of the absent meeter.

Similarly, where airports or other such locations do not allow people meeting passengers to wait in the arrivals area, the passenger can find themselves outside the airport building before they realise that the person meeting them is not there. They can subsequently be ambushed by taxi drivers, local traders or trolley pushers, etc. Finally, where there is a high level of overcrowding, and/or where there are several different directions in which an arriving passenger may exit, it is easy to simply not see the person designated to meet an arriving passenger.

The present invention seeks to address one or more of these problems by providing a position co-ordination system for co-ordinating a position of a number of users, the system comprising at least one user terminal, at least one mobile communications device, and a network connecting the at least one user terminal and the at least one mobile communications device, wherein the at least one user terminal is configured, upon receiving identification information from a first user, to determine a second user who is registered with the system to meet the first user, and to notify a mobile communications device associated with the second user via the network, thereby notifying the second user of the first user's position and facilitating meeting of the two users. The users may be unknown to each other. Alternatively, they may be known to each other.

Preferably, the system includes means for storing information associated with one or more second users registered to meet first users, and the second user is identified by the user terminal performing a comparison of the identification information provided by the first user with that associated with the registered second users. More preferably, identification of the second user occurs if the comparison yields an exact match, or if the comparison yields a near match that is selected by the first user.

Preferably, the at least one user terminal includes a bank of mobile communications devices, the mobile communications devices within the bank being releasable upon identification, at the user terminal, of a second user. Alternatively, the system further comprises a bank of mobile communications devices in communication with the at least one user terminal, the mobile communications devices within the bank being releasable upon identification at the bank of a second user. In this latter case, the bank of mobile communications devices may include a user interface, the user interface enabling the identification of a user requiring a mobile communication device. Additionally, the mobile communications devices may be rechargeable, and the bank may include a charger operative to recharge the mobile communications devices.

Preferably, the bank of mobile communications devices includes means to sense the release of a mobile communications device, and to sense its replacement. More preferably, the means for sensing are selected from a bar code reader, a chip reader and/or a data port reader.

In a preferred embodiment, the mobile communications devices are released from the bank based upon a degree of charge. Preferably, upon notification, the mobile communication device is operative to emit vibrations, light, sound and/or to display information. Preferably, the at least one mobile communications device includes a display, the display being operative to display data that is transmitted to the mobile communications device via the network. More preferably, the mobile communications device includes means for acknowledging, via the network, receipt of the notification.

In a preferred embodiment, the mobile communications device includes an alarm mechanism that emits a warning when the device exceeds a predetermined distance from the user terminal. In another preferred embodiment, the mobile communications device includes an alarm mechanism that emits a warning when a charge level of the device's battery falls below a predetermined level. Preferably, the mobile communications device includes one or more of an MP3 player, an MP4 movie player and a linkage to a radio broadcast. More preferably, the mobile communications device has applied to it a unique identification.

In another preferred embodiment, notification is via a closed loop transmission system. Preferably, notification is achieved via an RS232 transmitter in the at least one user terminal or connected to the at least one user terminal. More preferably, notification utilises Wireless Fidelity (WIFI), Ultra High Frequency (UHF), Very High Frequency (VHF) or Bluetooth methods.

In still another preferred embodiment, the user terminal includes a user interface. Preferably, the user interface is a touch-screen interface. More preferably, the user terminal includes a card reader device.

In another preferred embodiment, the user terminal is in communication with a control module via a secure private network. Preferably, the at least one user terminal includes means for generating an operation log and/or information relating to the correct generation of the user terminal, and the control module includes means for monitoring the operation log and/or information. Preferably, the user terminal includes means for forwarding, to the control module, periodically the operation log and/or information. More preferably, the control module includes means for updating the system. Still more preferably, the means for updating the system is operative to update a configuration of the system and/or a configuration of the at least one user terminal. Still more preferably, the at least one user terminal is configured to poll the control module means for updating periodically.

The present invention also provides a method of co-ordinating the position of a number of users of a position co-ordinating system, comprising the steps of receiving identification, in the system, of at least one second user, issuing a mobile communications device to the second user, receiving identification, in a user terminal of the system, of at least one first user of the system, determining, in the user terminal, a second user who is registered with the system to meet the first user, and notifying the mobile communications device issued to the determined second user, via a network, that the first user has identified themself to the user terminal, thereby notifying the second user of the first user's position and facilitating meeting of the two users.

In one embodiment, the identification of the second user is received in the user terminal. In an alternative embodiment the identification of the second user is received in a bank of mobile communications devices that is communicatively coupled with the user terminal.

Preferably, the identification of the first user includes a user name and, optionally, a security code. The identification of the second user may also include an indication of user type, a user name of a first user and, optionally, a security code.

In a preferred embodiment, payment authorisation is requested from the second user and is received prior to the issuance of the mobile communications device.

In another embodiment, the second user is determined by the performance of a comparison of the first user's user name with the user names associated with all registered second users, and the mobile communications device of the second user is notified upon locating a match. Preferably, if a match is not determined the step of providing the first user with a list of possible matches is performed and, upon selection from the list, notifying the mobile communications device associated with the second user associated with the selection. If an appropriate match does not exist, the first user may be provided with instructions as to what action to take.

Preferably, the mobile communications device has a unique identity that is visibly applied to it, and wherein the first user is provided with the unique identity once the signal has been acknowledged, thereby allowing their recognition of the bearer of the mobile communications device.

In one embodiment of the invention, the method includes the step of monitoring the operation of the system and/or monitoring the system for malfunctions. Preferably, the method also includes the step of providing to a control module from the user terminal an operation log and/or information relating to the current operation of the user terminal, and monitoring, in the control module, the log and/or the information. The step of providing is preferably carried out periodically.

Preferably, the method includes the step of updating a system configuration and/or a configuration of the user terminal. The configuration of the user terminal is preferably updated periodically upon initiation of an update procedure by the user terminal.

In a preferred embodiment, once the first and second users have met, the mobile communications device is reattached to the bank. In a further preferred embodiment payment is also processed and a receipt is printed.

### BRIEF DESCRIPTION OF THE DRAWINGS

Specific embodiments of the present invention are now described by way of example only, with reference to the accompanying drawings, in which:

FIG. 1 is an overview of the system of the present invention;

FIG. 2 is a more detailed partial representation of the system of FIG. 1;

FIG. 3 is a flow diagram representing the use of the system of the invention;

FIG. 4 is a flow diagram depicting the updating of the system of the invention; and

FIG. 5 is a flow diagram depicting the monitoring of the system of the invention.

### DETAILED DESCRIPTION OF THE INVENTION

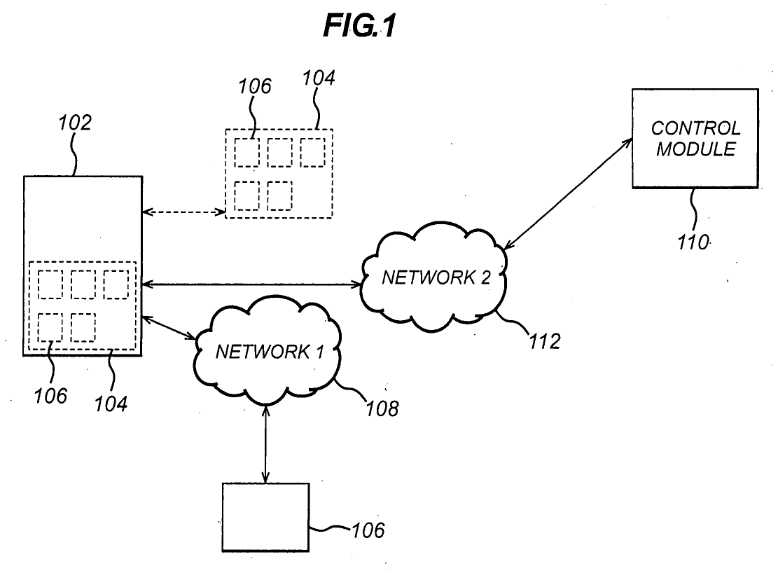

FIG. 1 shows an overview of the system of the present invention. The system consists of a number of discrete modules. Firstly, there is a user terminal 102. This is preferably a touch-screen terminal, but may be a terminal of other variety. The user terminal is the terminal at which, in the example that is being used throughout this description, airline passengers arriving at an airport enter their details as will be described more fully below.

The system also incorporates a bank 104 of mobile communications devices 106. As will be appreciated from FIG. 1, the bank 104 of mobile communications devices 106 may be provided as part of the user terminal 102 or may stand alone. In the latter case, the bank 104 will be connected directly to the user terminal 102, either via hard wiring or by wireless means.

The bank 104 is also accessible via a touch-screen terminal. This touch-screen terminal is that of the user terminal 102 or a separate touch-screen terminal incorporated in the bank 104. The user terminal 102 or bank 104 is therefore operative to receive input from users meeting arriving passengers (referred to hereinafter as meeters) and optionally enables payment for the use of the system. The bank 104 releases mobile communications devices 106 and receives these devices when they are returned. The bank 104 also incorporates a charging device (not shown). This charging device serves to charge each mobile communications device 106 that is present within the bank. Accordingly, when a mobile communications device 106 is docked within the bank, the bank charges continuously a rechargeable battery within the mobile communications device 106 until it is fully charged. Preferably, the charger is a high-speed charger which serves to provide a battery charge duration of approximately 24 hours, when fully charged.

When a mobile communications device 106 is released from the bank 104, the device 106 with the highest degree of charge is released, as long as the amount of charge is sufficient for operation. To enable this, the bank 104 includes a bar code reader, and/or a chip reader and/or a data port reader which senses when a mobile communications device 106 has been removed, and senses when it has been replaced, thereby ending a transaction and optionally enabling the user to whom the device was released to be charged on a charge per block of time basis or the like. Additionally, the bank 104 is operative to measure the amount of charge in each device 106 that is docked and to sense which devices are docked in which docking ports within the bank.

The third element within the system is the mobile communications device 106. Each mobile communications device is a hand-held device that is distributed to a person registering as a meeter with the system. The meeter carries the mobile communications device with them around the airport in the present example. The mobile communications device 106 includes means to notify the meeter that their passenger has arrived and is waiting to be met. These means may take the form of means causing the device to vibrate, LEDs on the device being caused to flash or simply to be illuminated, the presentation of an audible warning or message, or the presentation of data on a display unit integrated with the mobile communications device 106. Optionally, the mobile communications device is enabled to receive flight data from the airport's arrivals system, for example via SMS messaging, and to display it on the integrated display unit.

The mobile communications devices 106 are preferably of restricted range. This means that meeters registered with the system will remain within a predetermined close range of the user terminal 102. Hence, arriving passengers will not be kept waiting for long periods after instigating operation of the system as will be described below. In this embodiment, each mobile communications device 106 incorporates an alarm which is activated upon the mobile communications device 106 being taken out of range, i.e. past the predetermined distance. This feature also serves to notify meeters who are in possession of a mobile communications device 106 that they remain in possession of that device 106 if they erroneously attempt to leave the premises whilst still in possession, thus serving to prevent the mobile communications devices from going missing.

Alternatively, the mobile communications device 106 may have stored within it a number of visual or audible messages, such as “You are going out of range” “Your passenger flight status is: “Baggage in Hall” or “Landed”, and “Power Low, please return to terminal”. Such messages may be triggered for display and/or audible presentation by the delivery to the mobile communications device 106 of a trigger signal associated with the required message.

The terminal 102 is in communication with each mobile communications device 106 via a network 108. The network 108 is part of a closed loop transmission system, i.e. it is a closed network. A closed network is a network to which only specific devices, in this instance the mobile communications devices 106, can connect and thus communicate with the system. No outside devices are able to connect to the network. The closed network utilises one of Wireless Fidelity (WIFI), Ultra High Frequency (UHF), Very High Frequency (VHF) or Bluetooth, in conjunction with an RS232 transmitter device or an RS232 transmitter/receiver device. The RS232 device may be present in the terminal 102, but is not shown in FIG. 1. Alternatively, it may be merely connected to the terminal 102.

In a preferred embodiment, the terminal 102 or the bank 104 includes a credit, debit or account card payment system. Registration of a credit or account card with the system, in this embodiment, activates the release of a mobile communications device 106 from the bank 104. Upon return of the mobile communications device 106, payment is processed based upon a fixed charge, or a time based charge for example.

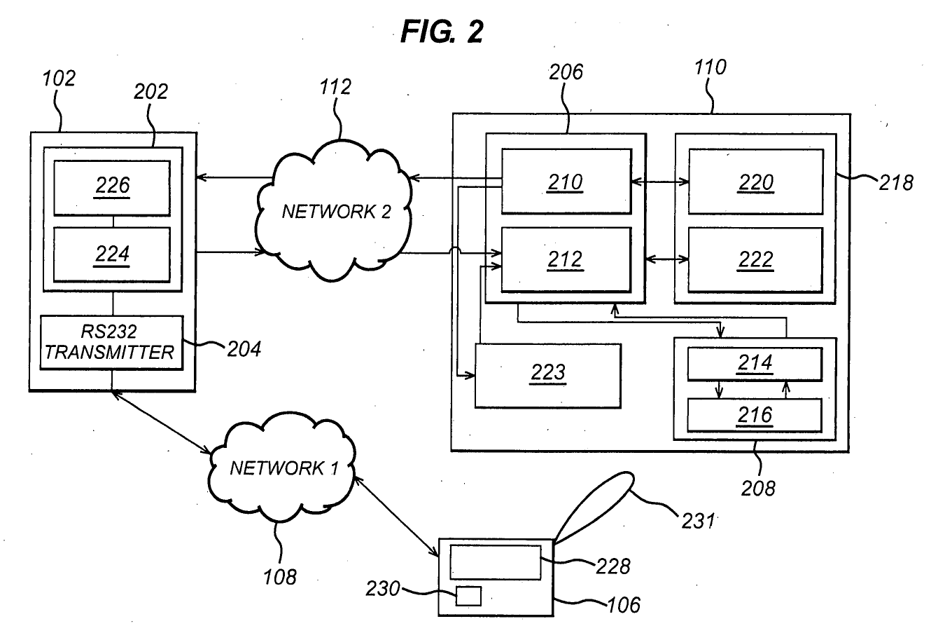

Finally, a system control module 110 is connected to the user terminal 102 via a second network 112. The system control module is operative to control, monitor and update the system depicted in FIG. 1. These features are described in more detail below with reference to FIG. 2.

It will be appreciated that the system described above finds application in many situations. For example, it may be extended into train stations, and large hotel lobbies. A further use, for a longer range version, exists in respect of airports with pickup areas for cars. A mobile communications device can be collected from a drive past user terminal 102 and the driver can then go to a nearby waiting area or cafe. They will then be notified of the arriving passenger's arrival and may drive to a collection point to collect that passenger. A similar refinement is applicable in respect of retrieving a car from valet serviced car parking facilities. An arriving passenger identifies themselves to a user terminal 102 which notifies the valet service of their arrival, and the passenger's car is brought to a collection point.

As will be appreciated, FIG. 1 depicts the system of this invention in its most limited form. The system may readily encompass a plurality of user terminals 102. It may also encompass a plurality of banks 104 of mobile communications devices 106. In such embodiments, each user terminal may be connected to each mobile communications device 106 via the network 108. Moreover, each user terminal 102 may be connected to each bank 104. It is also feasible that a plurality of user terminals 102 are provided within the system, but a single bank 104 only is included. In embodiments in which there are plural user terminals 102, the distance from the user terminals at which an alarm on a mobile communications device sounds is predetermined to be a distance from a nearest user terminal.

FIG. 2 shows a more detailed representation of various elements of FIG. 1 and describes the way in which the system is implemented and managed. The system of the present invention is implemented in the form of a client/server system. This approach enables the control module 110 to monitor the user terminals 102 present within the system to ensure that they are all operational, to track their usage, to run central accounting procedures and to update remotely the operation of each user terminal 102.

As will be apparent, each user terminal 102 incorporates a touch-screen 202. Each user terminal 102 also incorporates, or is connected to, an RS232 transmitter or transmitter/receiver 204 as already noted. The RS232 transmitter or transmitter/receiver facilitates communication with each mobile communications device 106 via the network 108.

Each touch-screen terminal 202 is linked to a Web Server 206 and to a Database Server 208, preferably a Structured Query Language (SQL) Database Server via a second network 112. This second network is preferably an Asymmetric Digital Subscriber Line (ADSL) or Virtual Private Network (VPN) link. Alternatively, it may be an Integrated Digital Services network (ISDN) link or a dial up connection. However, the touch-screen terminals 102 are stand-alone and can operate independently of these servers if required. In such an embodiment, user terminals 102 can be located in places where an ADSL/VPN link/ISDN link/dial up connection is not possible or viable, and the user terminals 102 can be maintained and updated locally or manually. The Web Server 206 incorporates a data repository 210 and usage log 212 module. The usage log module 212 stores raw log files that are received from each user terminal, preferably in XML format, as will be described later. The operation of the data repository is discussed in more detail below.

The Database Server 208 incorporates a procedures module 214 and a data module 216. The procedures module 214 stores custom built procedures that are created to process information. The procedures may include processes for gathering historical information on the usage of user terminals, processing logs as will be described later, and updating user terminals (also described later). The operation of the data module is discussed in more detail below.

The control module also incorporates an administration machine 218. The administration machine incorporates a system and content manager 220 and a report generation module 222. The administration machine 218 is configured to monitor the system from any remote location. It therefore monitors the usage and performance of the system, including each of the user terminals 102. The administration machine 218 is also operative to generate reports based upon the monitoring of data. For example, financial reports, reports on print stock level, reports on missing mobile communications devices 106, and reports on the charge rate and/or level of mobile communications device 106 batteries are produced by the administration machine report generator 222. These reports are produced by calling a stored procedure from the procedures module 214 of the Database Server 208, the procedure being such as to produce the required report. Finally, the control module also incorporates some form of user terminal 223, which may be for example a touch-screen terminal or a standard pc.

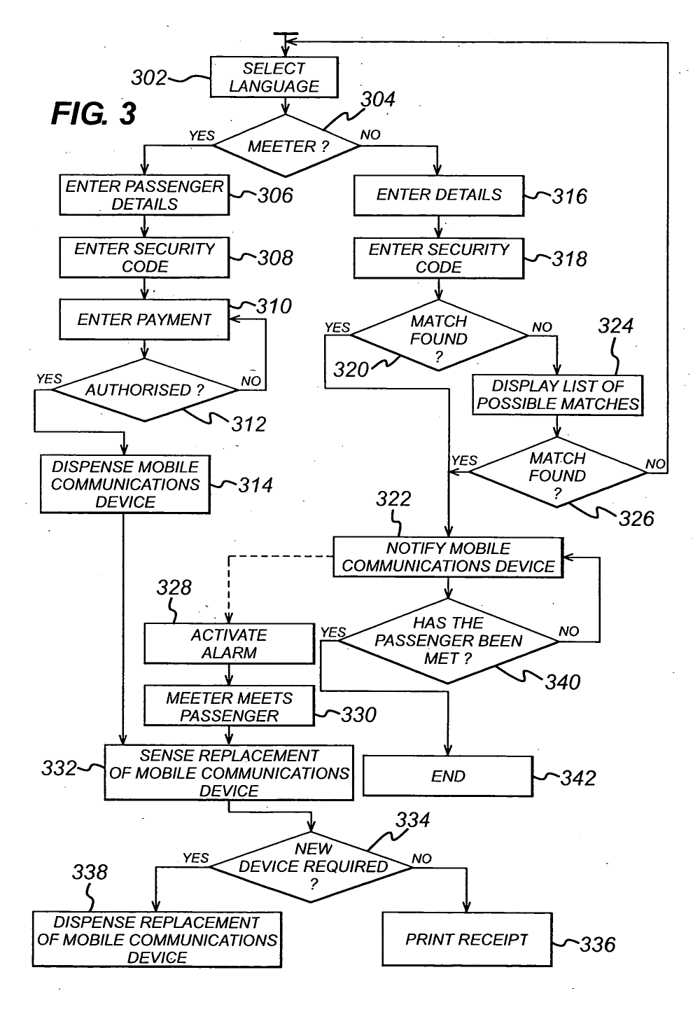

In a preferred embodiment, the user terminal 102 comprises a housing, preferably of aluminium although other suitable materials may also be used. This housing contains an operating system or processor 224, the touch-screen display 202 and optionally a payment mechanism (not shown). The user terminals are stand-alone modules enabling single or multiple installations. These are linked, as already described with reference to FIG. 1, to the one or more banks 104 of mobile communications devices 106 in order that the processor 224 of the user terminal may trigger the release of a mobile communications device 106. The processor 224 runs a user terminal application 226 to carry out the present invention, as will be described below with reference to FIG. 3. Of course, in embodiments in which the bank 104 employs a touch screen, a processor running an application will be present in the bank also. In this case the mobile communications device will be released by the bank under the control of the bank processor running the bank application.

The preferred specification for the user terminal 102 is as follows. The user terminal 102 is a stand-alone vandal resistant kiosk with a 17-inch touch-screen. It includes an 80 millimetre built in printer, a card reader—both magnetic and chip and pin compliant, a trolley protection bar, and an RS232 transmitter or transmitter/receiver. Optionally, an anti vandal keyboard with track ball is included.

Referring now, in more detail, to the mobile communications devices 106, these comprise a paging device which vibrates and flashes when paged. Preferably, this is located within a housing which is sized so as to avoid users placing it in their pockets and forgetting that it is there. The size of the housing is also configured to enable branding and/or advertising opportunities. As already noted, the mobile communications device 106 includes a small screen 228, preferably a liquid crystal display (LCD) screen. In locations where flight data, for example, is available to be transmitted, via short message system (SMS) messages for example, such information may be sent to and received and displayed by the device 106 on the screen. The mobile communications device 106 is adapted to receive such data and to display it on the display 228.

The mobile communications device 106 may also include an acknowledge function, which may take the form of a button 230. This function, when activated for example by pressing button 230, passes an acknowledgement signal, via the network 108, to the user terminal 102 and its processor 224. As will be apparent from the description to follow, the acknowledge function is used in response to the receipt of a notification at the mobile communications device 106.

Each mobile communications device 106 preferably has a unique identification number, symbol, code or the like, optionally in combination with a colour, printed on it. This information is provided to an arriving passenger upon their identifying themselves to the user terminal 102. This information enables the arriving passenger to identify their meeter, thereby preventing the necessity for the arriving passenger's name to be displayed by the meeter. This is obviously a desirable feature for celebrities or persons wishing to retain a low profile when travelling. It is also useful in preventing the abduction of people arriving at an airport, for example.

Each mobile communications device 106 includes a low battery charge level warning function. When the battery reaches a certain level of discharge, this function warns the user that the battery is low, triggering the user to return to the bank 104 and to swap the mobile communications device 106 for another which has a higher level of charge. A further warning mechanism is included within each mobile communications device 106, as already noted, which detects when the device 106 is taken more than a predetermined distance (preferably no more than a 3 minute walk, for example) from the user terminal 102 or terminals.

Preferably, the mobile communications device 106 is manufactured to be robust such that it can withstand being dropped. It also preferably has a lanyard option 231 to make it convenient to carry. Further possible features are the presence of a built-in MP3 player with headphones, a linkage to a locally transmitted radio broadcast and/or a built-in MP4 movie player. In such circumstances, the mobile communications device 106 is configured to interrupt the MP3 player, locally transmitted radio broadcast or MP4 movie player when a notification is received from the system.

The operation of the system of the invention is now described with reference to FIG. 3. When a person designated to meet a passenger arriving, in this example, at an airport, arrives, they approach the user terminal 102, and interact with it and thus the system via the touch-screen 202. Initially, upon activating the user terminal 102, which may be in a dormant state to preserve the screen or which may be playing media such as advertisements, the meeter is presented with a screen inviting them to swipe an account/credit/debit card in the terminals' card reader, a screen offering a fast track service, a screen providing information on how to use the system in a local language and having a language choice option, or a screen offering a choice of languages. Of course, other screens may be displayed initially also. Once the first screen has been interacted with by a user, for example where a choice of languages is presented upon selection of an appropriate language, from an available list of languages (function box 302), the user is prompted, via a graphical user interface for example, to identify themselves as a meeter or otherwise (function box 304). When identifying themselves as a meeter, the meeter may be presented with an overview of the operation of the system of the invention if such has not already been presented. An option to skip the overview may also be presented by means of the touch-screen 202. Alternatively, the overview may be available via a help function and thus not presented automatically. It will be understood that these choices and options are provided by the processor 224 in accordance with the controlling application 226, as are those described below.

Next, the meeter is prompted by the user terminal, via the touch-screen 202, to enter the details of the passenger whom they are meeting. Various details may be entered including, in this example, one or more of the passenger name and the passenger's flight number (function box 306). Additionally, if a security code has been agreed with the passenger that is being met, a security code is entered by the meeter when prompted by the user terminal (function box 308). If no security code is entered at this point, access to the passenger details is available via the user terminals 1 02 without code protection. The details entered by the meeter are stored within a memory in the user terminal, along with the details associated with all other meeters registered with the system to meet arriving passengers.

In an embodiment of the invention in which payment is required for use of the service, details of charges levied for the use of the service are displayed to the meeter prior to entry of the passenger's name and any security code. Acceptance of the terms of use is implied by the meeter then entering the passenger's details and any agreed security code. Payment or payment authorisation is then requested in function box 310 depending upon the systems configuration. Payment authorisation may be provided by swiping a credit or debit card or an account card when the user terminal is connected to the second network. Alternatively, a cash payment, debit card payment, or pre-paid card payment mechanism or the like may be provided when the user terminal is operating in a stand alone configuration. In the case of payment authorisation, the card reader will read the details of the card holder via the magnetic strip or card chip, and will seek authorisation, from the credit or account card provider, for payment (function box 312). If authorisation is not given, the meeter is asked to enter payment once again (function box 310) a finite number of times before defaulting to the start of the process. However, if payment is authorised in function box 312, a mobile communications device is dispensed from the bank 104 of mobile communications devices 106 (function box 314). This is achieved by the provision of a signal from the user terminal 102, generated by the processor 224 in accordance with the application 226, to the bank 104, which in response releases the mobile communications device 106 that has the highest degree of charge. In the case of cash, debit cards and pre-paid account cards the user is debited a fixed amount for use of the system. This is appropriate in embodiments in which a fixed charge is levied.

When processing payment via credit or account card, the system will connect with credit card or account card clearing systems as appropriate. Connection with these services is achieved via network 112 and web server 206.

Returning to function box 304, if a user of a system identifies themselves, at the user terminal 102 via the touch-screen 202, as a passenger desiring to be met by a prearranged meeter, the passenger is prompted to enter their details (function box 316). Again, details may include the passenger's name and/or flight number or other flight information. Some or all of these details may optionally be read from a debit, credit or account card or the like via the user terminal card reading facility. The user is then prompted, again by the user terminal 102 under the control of the user terminal processor 224 running the user terminal application 226, to enter a security code, if a security code has been agreed (function box 318).

The user terminal 102 then carries out a comparison of the details entered by the passenger with the details entered by all meeters who have registered with the system. If a match is determined (function box 320), the match is displayed to the passenger via the touch-screen 202 and if the passenger agrees with the match, and indicates agreement via the selection of an affirmative button on the touch-screen 202 for example, a signal is sent, via the network 108, to the selected meeter's mobile communications device to notify that device of the passenger's arrival (function box 322). Notification in this way informs the meeter who is in possession of the signalled mobile communications device that the passenger has arrived and is waiting at the user terminal 102. The mobile communications device 106 in question brings the notification to the attention of the meeter in any one or more of the ways already described. The meeter may acknowledge receipt of the notification by employing the acknowledgement function provided by the mobile communications device 106.

At this point in the procedure, the user terminal 102 displays the number and/or colour associated with the mobile communications device 106 in the possession of the appropriate meeter. This information may be printed out for the passenger to retain. The printed details include a unique identification so that, should the passenger need to call the meeter again, they do not need to re-enter their details. Merely entering the unique identification when prompted for details by the terminal 102 is sufficient to initiate a notification signal being sent to the mobile communications device 106 in question. The passenger is also instructed to wait in the area of the user terminal or in a designated waiting area.

In function box 320, if a match is not found, the passenger is presented, via the touch-screen 202 of the user terminal 102, with possible matches, (which may or may not exclude meeters whose entries are protected by security codes). In one embodiment, the matches may be based on predefined match parameters and tolerances, for example 90% of the same characters in the entered name and/or the same flight number. This list is displayed for the passenger's perusal (function box 324). If one of the suggested matches is correct, the passenger selects it and indicates it as a match via an affirmative option available through the user terminal 102 under the control of the processor 224 running the application 226 (function box 326). Upon selection of an appropriate match, the selected mobile communications device is notified (function box 322). If a match is not found, the passenger is notified of the procedure to follow. In this example, the passenger is directed to the airport information desk for assistance. The system then reverts to its waiting status as the session is complete.

Upon receipt of a notification from the user terminal 102, the mobile communications device 106 activates an alarm of any of the forms already described to notify the meeter in possession of the device 106 that the passenger they are awaiting has arrived and is at the user terminal 102 or one of the user terminals (function box 328). The meeter then makes their way to the user terminal where the passenger is able to identify them by virtue of the colour and/or code associated with the mobile communications device 106 (function box 330) which is displayed by the meeter. Once the passenger has been met, the meeter replaces the mobile communications device 106 in the bank 104.

The bank 104 senses the replacement of the device and queries the meeter as to whether the device 106 is being replaced because a replacement device 106 is required (because the battery is running low) or if the passenger has been met successfully (function box 334). If the passenger has been met, a log of the transaction is produced and printed out. In embodiments of the invention in which a charge is levied for the use of the system, a credit, debit or account card, or other appropriate, receipt is produced indicating the charge that has been levied for use of the system, which may be based upon a standard charge and/or the duration of use (function box 336). However, in function box 334, if it is established that the mobile communications device 106 is being reattached in order that a replacement is issued, the user terminal 102 dispenses a replacement mobile communications device 106 and automatically reassigns the passenger details associated with the replaced mobile communications device 106 to the newly dispensed device 106 (function box 338).

Once a notification has been sent to a mobile communications device (function box 322), the user terminal 102 monitors the bank 104 of mobile communications devices 106 to determine whether the mobile communications device 106 that has been notified is replaced in the bank and whether this replacement is because the passenger has been met. Once it is determined that the passenger has been met (function box 340), the process comes to an end (function box 342). However, if, after a predetermined period of time, it is determined that the passenger has not been met by the meeter (function box 340), the procedure returns to function box 322, where the selected mobile communications device 106 is notified once again. This procedure may be performed automatically by the user terminal or may rely upon the waiting passenger entering the unique code associated with the meeter's mobile communications device 106 after a period of time.

As already mentioned above, when it is not being used, the user terminal may employ an attraction mode to attract users to the screen. The attraction mode may start after a set period of inactivity and may include advertisements for local services, i.e. services available at the airport. In the attraction mode, a flash movie may be presented inviting users to “touch the screen” alternating with pages of content to attract users to the screen. Furthermore, the mobile communications devices 106 include a small display screen 228. This may additionally be used for advertising purposes. For example, adverts for facilities available within the arrivals area of the airport may be advertised. This feature may furthermore be tied in with flight delays, i.e. it may be activated when the flight of the passenger that the meeter is awaiting is delayed. The user terminal 102 may also be provided with a search facility to allow users to search for services in the local area and to link with proprietary search facilities.

The interface that links the client/service system together is not a website running from the Internet, it is also not a local website running from a local database. As is apparent from FIG. 2, each user terminal 102 holds files locally (i.e. application 226). Hence, the system is impervious to Internet or network failure and requires less bandwidth. In an alternative embodiment, a combination of local and remote files can be used. In this instance, in-built security measures are included to prevent the user from accessing any remotely held information that is not intended for user access. It will be appreciated that the use of locally held files in the present invention is distinctly advantageous because local files appear instantly on the touch-screen 202, even when large documents, files and multimedia elements are displayed.

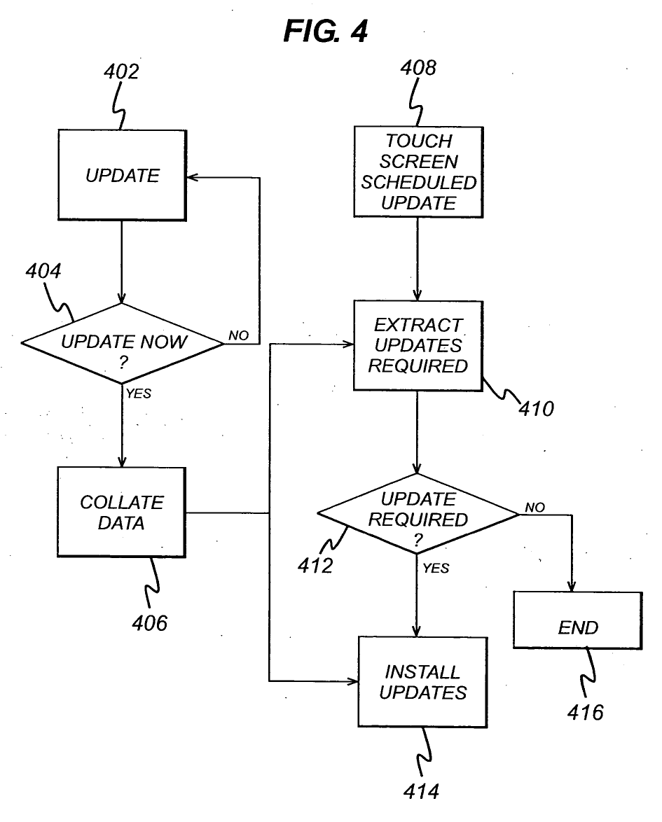

The procedure for updating the system of the invention is now described with reference to FIGS. 2 and 4. As will be appreciated from FIG. 2, the user terminal 102 is connected to the control module 110, in a preferred embodiment, via a secure VPN. A VPN is a closed network which is restricted by Internet protocol, user name and password identification means. This means that the network only allows selected computers (ones with the correct IP address) to log on. A firewall restricts the Internet protocol addresses and the virtual private network is secured by requiring entry of a user name and password for access. This allows remote access to the system if security privileges are correct. The database server 208 is hosted at the same location. Moreover, the report generation module 222 present in the administration machine 218 is available via a browser to a fire walled secure area.

The administration machine 218 controls the entire system. It correlates data from the database server 208 for the purposes of generating reports and facilitates the updating both of media and data on each user terminal 102 within the system. The administration machine 218 can be, for example, implemented on any personal computer with a suitable specification. Access to the administration machine is controlled via an Internet protocol based firewall. Encrypted user name and password identification is also required.

The administration machine 218 is operative to update the web server 206 and database server 208 with new information upon demand. This is performed via the system and content manager 220. Each user terminal 102 is, however, scheduled to check update information held in the database server 208 data module 216 at set intervals.

FIG. 4 shows the steps that are carried out in order to update the system of the invention. Updating commences in function box 402. The administration machine 218 is operative to allow an administrator of the system to make modifications to all user terminals within the system. Modifications that may be made include touch-screen design and functionality. Moreover, system control may be modified in order to add additional user terminals, and thus touch-screens 202 to the system, and to change the scheduled update times for user terminals within the system. Once the administrator has made the updates that are required, the administration machine 218 prompts the administrator to determine whether the update should be applied to the system at this time, or at a later time (function box 404).

If it is determined that the update should be applied at this time, the administration machine 218 parses all the changes that have been made and bundles the information (data and/or new media) and sends it, preferably via XMLpost, to the database server 208 (function box 406).

Each user terminal 102 within the system has a predefined time at which it will interrogate the database server 208 in order to ascertain whether there are any updates available. Function box 408 shows the automatic update request, at the scheduled time, of each user terminal 102. In function box 410 it is detailed how a scheduled update takes place. The database server 208 controls the entire system, providing, via data repository 210, information on logging and updates as well as system settings. Each user terminal 102 interrogates the data via an Active Server Pages (ASP) web page and sends to it a unique identity of the user terminal when doing so. The database server then sends back to the user terminal a number of locations of updates that need installing, if any. This information is available through the collation of data carried out in function box 406. If an update is required (function box 412), the user terminal 102 downloads and installs the packages that are identified as located in the database server 208 in chronological order (function box 414). If no update is required, the updating process ends (function box 416).

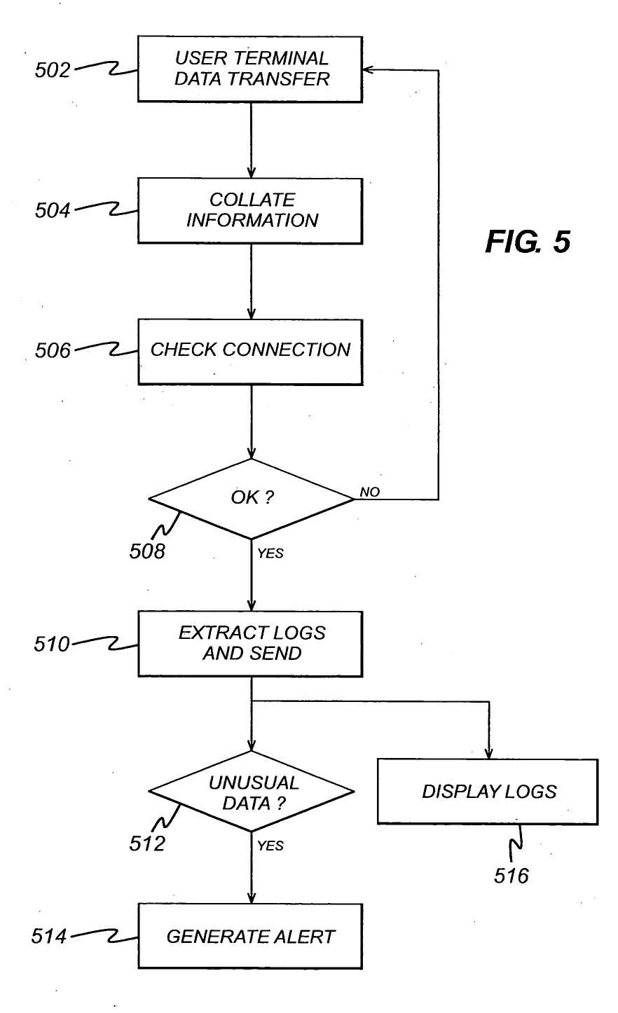

In addition to the above, each touch-screen is individually set to transfer data to the control module 110 at set periods of time for the purposes of system monitoring and report generation. Each user terminal 102 is configured to monitor its own operation. Operation logs are, in a preferred embodiment, sent once a day, and the results of the monitoring of the correct operation of the user terminal 102 are, in a preferred embodiment, sent once an hour to the control module 110. This ensures that if a problem occurs with one of the user terminals, the system knows. This step is represented by function box 502 in FIG. 5.

In function box 504, a user terminal 102 collates information available for updating the database server 208. In this step, the user terminal 102 determines when information was last sent to the control module 110 and thus, based upon the updating cycle, when data next needs to be sent. When it is determined that data needs to be sent to the control module 110, the connection between the user terminal 102 and the database server 208, e.g. the network 112, is checked by sending a small file to the database server 208 (function box 506). If a success message is received in response, the connection is present and a transfer of data may take place (function box 508). However, if a success message is not received in response, the process returns to function box 502 and the control module 110 is updated at a later time.

Once it has been determined that the connection is present and that a transfer may be carried out, the user terminal 102 extracts a log file from the user terminal (if logs are being transferred) and/or extracts monitoring information from the user terminal 102 (if monitoring information is being transferred). These log files and monitoring information (such as that necessary to create the reports mentioned earlier and user terminal operation information) represent information stored in the user terminal 102 since information was last sent to the database. This information is posted to an ASP web page, which inputs the information into the database 208. This is achieved as follows: the log files and/or monitoring information are transferred to the user log module 212 in the Web Server 206. The administration machine 218 checks the directory in which these are filed and collates the information. It then transfers it into the database server 208. A success message is passed by the database server 208 to the user terminal 102 upon completion (function box 510).

Triggers may be set on certain fields within the database server 208. The triggers are configured such that if any unusual data is inserted into the database from a user terminal 102, they are generated and the information causing the triggers is collated and sent to the system administrator or support department. This information may be sent by short message system (SMS) messages or e-mail, for example (function boxes 512 and 514). An example of data that may set off a trigger and thus an alert message is that the user terminal 102 central processing unit 224 voltage is too low or that the touch-screen display 202 is not working. The information is collated such that the alert sent to the administrator or support department includes an identification of the user terminal 102 in question, such as a name, location, and a description of the fault. As will be appreciated, the alert may be sent to as many destinations as required, in addition to the administrator/support department.

The data that is inserted into the database may also be displayed (function box 516), via, for example, a secure web page. This enables the administrator of the system and/or the support department or other appropriate person(s) or entity/entities, to view information on interaction, purchases, and errors for individual touch-screens within the system for specific locations or for the entire system.

It will be evident from the above that the present invention creates a simple, yet powerful and robust solution to the problem of a safe and efficient meeting of, for example, passengers arriving at an airport. It provides for people meeting arriving passengers to be notified precisely when and where their passenger is ready to be met. It ensures that a passenger has not walked past their meeter and prevents them from wandering around a terminal building, for example. It allows meeters to avail themselves of facilities in the arrivals area and provides an additional level of security/confidentiality by obviating the need for an arriving passenger's name to be on display. By achieving these advantages, the present invention results in more efficient meeting between passengers arriving at a location and the people designated to meet them, and thus reduces congestion in that location.

Although the present invention has been described with reference to passengers arriving in an airport terminal, it will be appreciated that the invention finds application in many equivalent situations and that it is therefore not to be construed as limited to the specifically described scenario. Moreover, it will be understood that this invention has been described above by way of example only, and that modifications of detail can be made within the scope of the invention

1. A position co-ordination system for co-ordinating a position of a number of users, the system comprising:
at least one user terminal;
at least one mobile communications device; and
a network connecting the at least one user terminal and the at least one mobile communications device;
wherein the at least one user terminal is configured, upon receiving identification information from a first user, to determine a second user who is registered with the system to meet the first user, and to notify a mobile communications device associated with the second user via the network, thereby notifying the second user of the first user's position and facilitating meeting of the two users.

2. A position co-ordination system as claimed in claim 1, wherein the system includes means for storing information associated with one or more second users registered to meet first users, and the second user is identified by the user terminal performing a comparison of the identification information provided by the first user with that associated with the registered second users.

3. A position co-ordination system as claimed in claim 2, wherein identification of the second user occurs if the comparison yields an exact match, or if the comparison yields a near match that is selected by the first user.

4. A position co-ordination system as claimed in claim 1, wherein the at least one user terminal includes a bank of mobile communications devices, the mobile communications devices within the bank being releasable upon identification, at the user terminal, of a second user.

5. A position co-ordination system as claimed in claim 1, the system further comprising a bank of mobile communications devices in communication with the at least one user terminal, the mobile communications devices within the bank being releasable upon identification at the bank of a second user.

6. A position co-ordination system as claimed in claim 5, wherein the bank of mobile communications devices includes a user interface, the user interface enabling the identification of a user requiring a mobile communication device.

7. A position co-ordination system as claimed in claim 4, wherein the mobile communications devices are rechargeable, and the bank includes a charger operative to recharge the mobile communications devices.

8. A position co-ordination system as claimed in claim 4, wherein the bank of mobile communications devices includes means to sense the release of a mobile communications device, and to sense its replacement.

9. A position co-ordination system as claimed in claim 8, wherein the means for sensing are selected from a bar code reader, a chip reader and/or a data port reader.

10. A position co-ordination system as claimed in claim 4, wherein the mobile communications devices are released from the bank based upon a degree of charge.

11. A position co-ordination system as claimed in claim 1, wherein, upon notification, the mobile communication device is operative to emit vibrations, light, sound and/or to display information.

12. A position co-ordination system as claimed in claim 1, wherein the at least one mobile communications device includes a display, the display being operative to display data that is transmitted to the mobile communications device via the network.

13. A position co-ordination system as claimed in claim 1 wherein the mobile communications device includes means for acknowledging, via the network, receipt of the notification.

14. A position co-ordination system as claimed in claim 1, wherein the mobile communications device includes an alarm mechanism that emits a warning when the device exceeds a predetermined distance from the user terminal.

15. A position co-ordination system as claimed in claim 1, wherein the mobile communications device includes an alarm mechanism that emits a warning when a charge level of the device's battery falls below a predetermined level.

16. A position co-ordination system as claimed in claim 1, wherein the mobile communications device includes one or more of an MP3 player, an MP4 movie player and a linkage to a radio broadcast.

17. A position co-ordination system as claimed in claim 1, wherein the mobile communications device has applied to it a unique identification.

18. A position co-ordination system as claimed in claim 1, wherein notification is via a closed loop transmission system.

19. A position co-ordination system as claimed in claim 18, wherein notification is achieved via an RS232 transmitter in the at least one user terminal.

20. A position co-ordination system as claimed in claim 18, wherein notification is achieved via an RS232 transmitter connected to the at least one user terminal.

21. A position co-ordination system as claimed in claim 19, wherein notification utilises Wireless Fidelity (WIFI), Ultra High Frequency (UHF), Very High Frequency (VHF) or Bluetooth methods.

22. A position co-ordination system as claimed in claim 1 wherein the user terminal includes a user interface enabling user input.

23. A position co-ordination system as claimed in claim 22, wherein the user interface is a touch-screen interface.

24. A position co-ordination system as claimed in claim 1, wherein the at least one user terminal includes a card reading device.

25. A position co-ordination system as claimed in claim 1, wherein the user terminal is in communication with a control module via a secure private network.

26. A position co-ordination system as claimed in claim 25, wherein the at least one user terminal includes means for generating an operation log and/or information relating to the correct generation of the user terminal, and the control module includes means for monitoring the operation log and/or information.

27. A position co-ordination system as claimed in claim 26, wherein the user terminal includes means for forwarding, to the control module, periodically the operation log and/or information.

28. A position co-ordination system as claimed in claim 25, wherein the control module includes means for updating the system.

29. A position co-ordination system as claimed in claim 28, wherein the means for updating the system is operative to update a configuration of the system and/or a configuration of the at least one user terminal.

30. A position co-ordination system as claimed in claim 28, wherein the at least one user terminal is configured to poll the control module means for updating periodically.

31. A method of co-ordinating the position of a number of users of a position co-ordinating system, comprising the steps of:
receiving identification, in the system, of at least one second user;
issuing a mobile communications device to the second user;
receiving identification, in a user terminal of the system, of at least one first user of the system;
determining, in the user terminal, a second user who is registered with the system to meet the first user; and
notifying the mobile communications device issued to the determined second user, via a network, that the first user has identified themself to the user terminal, thereby notifying the second user of the first user's position and facilitating meeting of the two users.

32. A method as claimed in claim 31, wherein the identification of the second user is received in the user terminal.

33. A method as claimed in claim 31, wherein the identification of the second user is received in a bank of mobile communications devices that is communicatively coupled with the user terminal.

34. A method as claimed in claim 31, wherein the identification of the first user includes a user name and, optionally, a security code.

35. A method as claimed in claim 31, wherein the identification of the second user includes an indication of user type, a user name of a first user and, optionally, a security code.

36. A method as claimed in claim 31, wherein payment authorisation is requested from the second user and is received prior to the issuance of the mobile communications device.

37. A method as claimed in claim 34, wherein the determination of the second user comprises performing a comparison of the first user's user name with the user names associated with all registered second users, and the mobile communications device of the second user is notified upon locating a match.

38. A method as claimed in claim 37, wherein if a match is not determined the step of providing the first user with a list of possible matches is performed and, upon selection from the list, notifying the mobile communications device associated with the second user associated with the selection.

39. A method as claimed in claim 38, wherein if an appropriate match does not exist, providing instructions to the first user.

40. A method as claimed in claim 37, wherein, the mobile communications device has a unique identity that is visibly applied to it, and wherein the first user is provided with the unique identity once the signal has been acknowledged, thereby allowing their recognition of the bearer of the mobile communications device.

41. A method as claimed in claim 31, including the step of monitoring the operation of the system and/or monitoring the system for malfunctions.

42. A method as claimed in claim 41, including the step of providing to a control module from the user terminal, an operation log and/or information relating to the current operation of the user terminal, and monitoring, in the control module, the log and/or the information.

43. A method as claimed in claim 42, wherein the step of providing is carried out periodically.

44. A method as claimed in claim 31, including the step of updating a system configuration and/or a configuration of the user terminal.

45. A method as claimed in claim 44, wherein the configuration of the user terminal is updated periodically upon initiation of an update procedure by the user terminal.

46. A method as claimed in claim 31, wherein, once the first and second users have met, the mobile communications device is reattached to the bank.

47. A method as claimed in claim 36, wherein, once the first and second users have met, the mobile communications device is reattached to the bank, payment is processed and a receipt is printed.

48. A position co-ordination system as claimed in claim 5, wherein the mobile communications devices are rechargeable, and the bank includes a charger operative to recharge the mobile communications devices.

49. A position co-ordination system as claimed in 5, wherein the bank of mobile communications devices includes means to sense the release of a mobile communications device, and to sense its replacement.

50. A position co-ordination system as claimed in claim 49, wherein the means for sensing are selected from a bar code reader, a chip reader and/or a data port reader.

51. A position co-ordination system as claimed in claim 5, wherein the mobile communications devices are released from the bank based upon a degree of charge.

52. A position co-ordination system as claimed in claim 20, wherein notification utilises Wireless Fidelity (WIFI), Ultra High Frequency (UHF), Very High Frequency (VHF) or Bluetooth methods.
